(19) United States
(12) Patent Application Publication
(10) Pub. No.: US 2009/0021864 A1
(43) Pub. Date: Jan. 22, 2009

(54) Method and apparatus for dynamically adjusting the ramp speed for loading and/or unloading sliders in a hard disk drive

(75) Inventor: Chao Yuan Chen, San Jose, CA (US)

Correspondence Address: GREGORY SMITH & ASSOCIATES, 3900 NEWPARK MALL ROAD, 3RD FLOOR, NEWARK, CA, 94560, US

(73) Assignee: Samsung Electronics, Co. Ltd.

(21) Appl. No.: 11/890,837

(22) Filed: Aug. 8, 2007

Related U.S. Application Data
(60) Provisional application No. 60/961,324, filed on Jul. 21, 2007.

(51) Int. Cl. G11B 5/60

(52) U.S. Cl. 360/234.3

(57) ABSTRACT

A Load-UnLoad (LUL) hard disk drive rotating its disks with ramp speeds when loading and/or unloading its sliders from its ramp based upon at least one atmospheric condition (AC) within the hard disk drive. Embodiments include load and unload ramp speeds that differ for a single AC, load ramp speeds that differ for differing AC, and/or unload ramp speeds that differ for differing AC. Also a method of operating such hard disk drive and its implementation within an embedded circuit.

### CROSS-REFERENCE TO RELATED APPLICATIONS

This application claims priority to U.S. Provisional Application No. 60/961,324, filed on Jul. 21, 2007, which is incorporated herein by reference.

### TECHNICAL FIELD

This invention relates to dynamically adjusting the ramp speed for loading and/or unloading sliders to and from a ramp based upon atmospheric conditions in a Load-UnLoad (LUL) hard disk drive.

### BACKGROUND OF THE INVENTION

Hard disk drives typically park their read-write heads in one of two ways, either by resting them on a special portion of the disk surface they access or by parking them on ramps which are located either at the outside diameter or near the inside diameter of the disks. The drives which rest their read-write heads on the disk surfaces are often referred to as Contact Start-Stop (CSS) hard disk drives. The drives parking their read-write heads and sliders on ramps are referred to as Load-UnLoad (LUL) hard disk drives. This application relates specifically to LUL hard disk drives.

LUL hard disk drives avoid some problems which CSS hard disk drives face, namely, the tendency for the sliders to stick to the disk surfaces through the static friction (stiction) effect as well as the wear and eventual damage to the disk surface resulting from the landing and take-off processes. The ramps of the LUL hard disk drives ensure that the slider is actually flying (that the disks are rotating at an operational speed so that the air bearing can form) before the slider ventures over the data zone of the disk surface. To date, these hard disk drives have used a fixed ramp speed, which does not account for the varying flying conditions of the air bearing of the slider resulting from changing atmospheric conditions within the hard disk drive, most notably but not limited to air temperature and pressure. What is needed are methods, and apparatus supporting those methods, for making and operating LUL hard disk drives which take into account the atmospheric conditions in the hard disk drive.

### SUMMARY OF THE INVENTION

Embodiments of the invention include a LUL hard disk drive using one or more atmospheric conditions to create two or more distinct ramp speeds for loading and/or unloading operations. By taking atmospheric conditions into account, the reliability of the LUL hard disk drive is improved by minimizing unwanted slider to disk surface contact.

As used herein, a load ramp speed is used to control the rotational speed of the disks rotated by the spindle motor when loading the sliders to engage a ramp, placing them in a protective position. An unload ramp speed is used to control the rotational speed of the disks when unloading the sliders from engagement with the ramp, removing them from their protective position for normal data access operations.

Embodiments of the invention may vary the load and unload speeds as required or desirable for increased performance and reliability. For example, a load ramp speed may differ from an unload ramp speed based on one or more atmospheric condition in the hard disk drive. Further, a first load ramp speed may differ from a second later load ramp speed, with the difference in speeds depending on differing atmospheric conditions in the hard disk drive. Similarly, a first unload ramp speed may differ from a second later unload ramp speed depending on differing atmospheric conditions in the hard disk drive.

### BRIEF DESCRIPTION OF THE DRAWINGS

FIG. 1 shows a plan view of a LUL hard disk drive embodiment with a rotating disk surface and a slider including a read-write head being positioned over the rotating disk surface by the voice coil motor pivoting through at least one actuator arm and a head gimbal assembly to the slider. The hard disk drive is shown with both an inside ramp and an outside ramp for illustrative purposes, but in practice the hard disk drive would normally include just one ramp;

FIG. 2A shows a perspective view of an embodiment of the voice coil motor of FIG. 1 including an actuator assembly with a voice coil coupled to the actuator arms and the head gimbal assemblies coupled to the actuator arms;

FIG. 2B shows a side view of an embodiment of the head gimbal assembly of FIGS. 1 and 2A, with a micro-actuator assembly including the slider flying on an air bearing created by the wind off of the rotating disk surface, a flexure finger coupling to the micro-actuator assembly, and to a load beam which provides a load tab for engaging the ramp to place the slider in a protective position when it is not being used to access the data of the rotating disk surface;

FIG. 3 shows in a schematic fashion further details of an example embodiment including the embedded circuit stimulating the spindle motor through a motor control interface generating a rotation control signal to rotate the disks at a ramp speed. The region of the slider in their head gimbal assemblies experience an atmospheric condition perceived through the use of an atmospheric condition sensor communicatively coupled to the embedded circuit, which preferably includes a processor creating an atmospheric condition estimate and using a ramp unload speed and/or a ramp load speed selected based upon the atmospheric condition estimate;

FIG. 4 shows a simplified mechanical side view of an embodiment of an LUL hard disk drive including an inside ramp where the load tabs of the head gimbal assemblies engage the inside load ramp to rest the sliders on the disk surfaces, which stop rotating;

FIG. 5 shows in a simplified schematic fashion a refinement of FIG. 3 where the LUL hard disk drive further includes a pressure sensor and a humidity sensor, both communicatively coupled to the processor in the embedded circuit.

FIG. 6A shows a flowchart of an example detail of the program system of FIG. 5F which may provide a load ramp control signal to the spindle motor based upon the atmospheric condition estimate when loading the ramp and/or provide an unload ramp control signal to the spindle motor based upon the atmospheric condition estimate when unloading the ramp; and

FIG. 6B shows a flowchart of another example detail of the program system of FIGS. 5 and 6A which may determine the load ramp control signal based upon at least one atmospheric condition estimate and/or may determine the unload ramp control signal based upon at least one atmospheric condition estimate.

### DETAILED DESCRIPTION

Embodiments of the invention include a Load-UnLoad (LUL) hard disk drive (hereafter: “hard disk drive”) using one or more atmospheric conditions to create one or more distinct ramp speeds for loading and/or unloading operations. By taking atmospheric conditions into account, the reliability of the hard disk drive is improved by minimizing unwanted slider to disk surface contact.

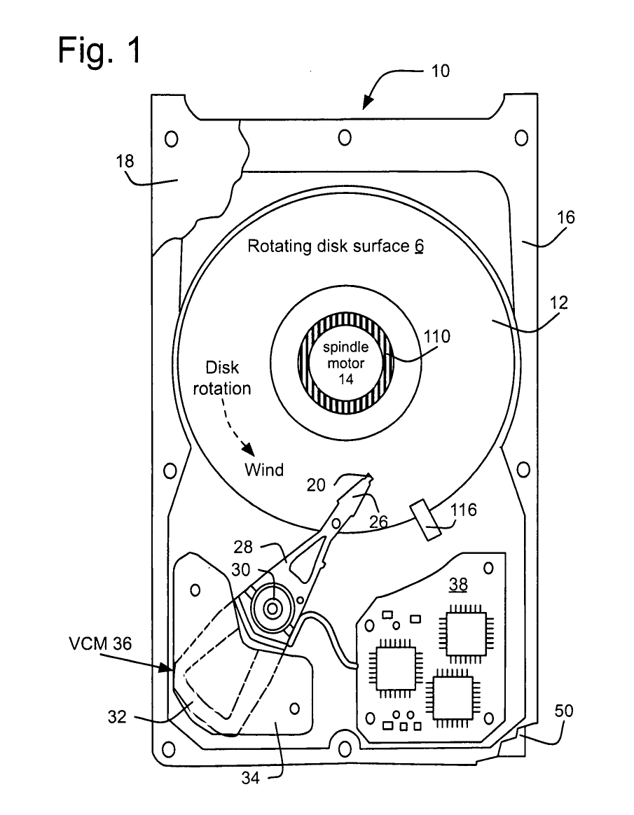

Referring to the drawings more particularly by reference numbers, FIG. 1 shows an embodiment of a hard disk drive 10. Some embodiments of the hard disk drive include an inside ramp 110, whereas others include an outside ramp 116. Most embodiments would not include both an inside ramp and an outside ramp as shown. The hard disk drive may include one or more ferromagnetic disks 12 rotated by a spindle motor 14 to create at least one rotating disk 6. The spindle motor may be mounted to a base plate 16. The hard disk drive may further have a cover 18 that encloses the disks 12. The voice coil motor 36 operates by pivoting an actuator assembly through the actuator pivot 30, moving the actuator arms 28 and their coupled head gimbal assemblies 26 to laterally position a slider 20 near a track on the rotating disk surface. The disk rotation causes a wind near the disk surface.

The hard disk drive 10 preferably includes an embedded circuit 50, which frequently provides for the encoding of data into the data payload of sectors before the sectors of a track are written to the rotating disk surface 6. In such embodiments, the embedded circuit also provides for the decoding of data from the data payload of sectors from the raw data read from the track on the rotating disk surface. The embedded circuit may further provide the control circuitry used to operate the voice coil motor 36, the spindle motor 14 and the hard gimbal assemblies 26. In certain embodiments of the hard disk drive, a printed circuit assembly 38 may also be mounted on the disk base 16.

When data access of the disks 12 is not needed, it is common to place the sliders 20 into a protective position on or under the inside ramp 110 or the outside ramp 116. Placing them into this protective position is called loading the ramp and removing them from the protective position is called unloading the ramp. This invention relates to the rotational speed of the disks when loading the ramp, called the load ramp speed and/or the rotational speed of the disks when unloading the ramp, called the unload ramp speed.

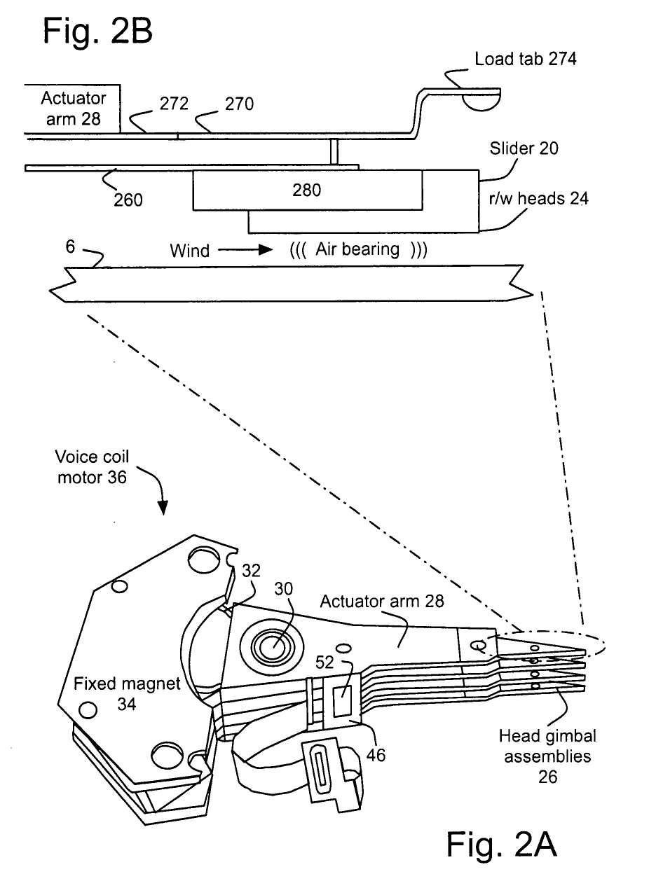

FIG. 2A shows some details of an example voice coil motor 36 of FIG. 1 including more than one actuator arm 28 and more than one head gimbal assembly 26, as well as a main flex circuit 46 and a preamplifier 52 included in the main flex circuit. In certain embodiments, at least one of the actuator arms may couple with two separate head gimbal assemblies. As used herein, the actuator assembly will refer to the voice coil 32 coupled to the actuator arms, which in turn are coupled to head gimbal assemblies in the hard disk drive. The voice coil motor 36 includes the actuator assembly pivotably mounted by the actuator pivot 30 to the disk base 16 positioned with the voice coil 32 between the fixed magnet assembly 34, and with at least one head gimbal assembly 26 situated so the slider 20 is near the rotating disk surface 6 during data access operations.

FIG. 2B shows some details of one embodiment of the head gimbal assembly 26 of the preceding Figures, with a micro-actuator assembly 280 including the slider 20, a flexure finger 260 coupling to the micro-actuator assembly, and to a load beam 270. The load beam couples through a base plate 272 to the actuator arm 28. The rotating disk surface 6 creates a wind that lifts the slider 20 on its air bearing off the disk surface 6. The air bearing has been found to be sensitive to atmospheric conditions. In certain situations, this sensitivity can cause unwanted contact between the slider and the disk surface when the hard disk 10 drive loads or unloads its ramp by engaging or disengaging the load tab 274 provided by the load beam. Load tabs are well known, and a variety of such tabs may be useable in the invention. The load tab 274 shown in FIG. 2B is particularly suited for use with an outside ramp 116 as shown in FIG. 1.

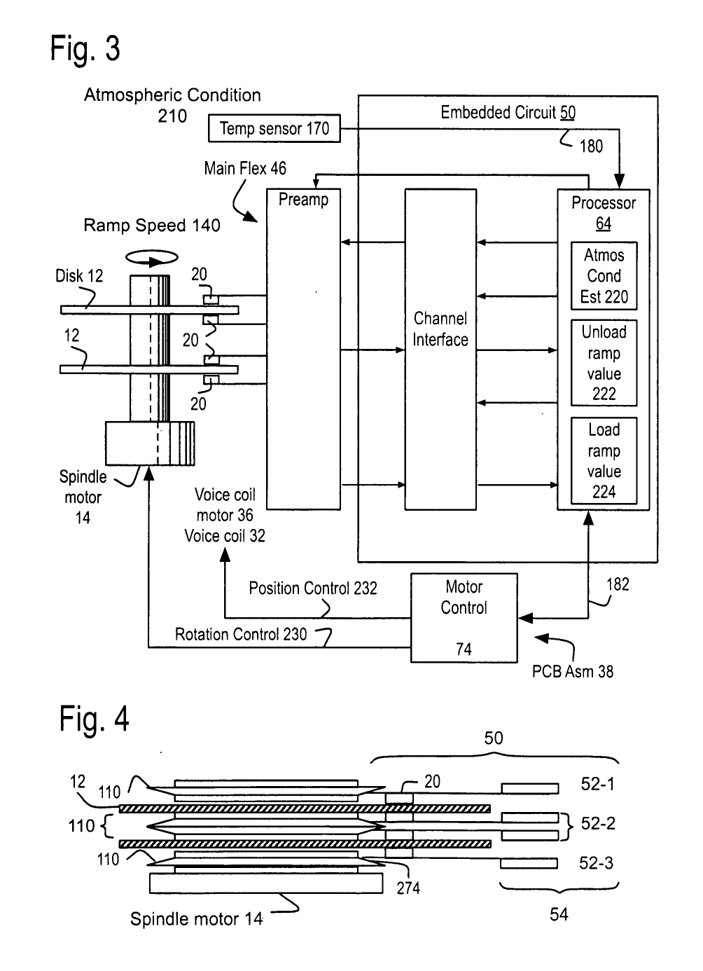

FIG. 3 shows in a schematic fashion some further details of the hard disk drive 10 of FIG. 1 including the embedded circuit 50 stimulating the spindle motor 14 through a motor control interface 74 generating a rotation control signal 230 to rotate the disks 12 at a ramp speed 140. The region of the slider 20 and the rotating disks 12 experiencing an atmospheric condition 210 is perceived through the use of at least a temperature sensor 170 communicating via communication coupling 180 to the embedded circuit 50.

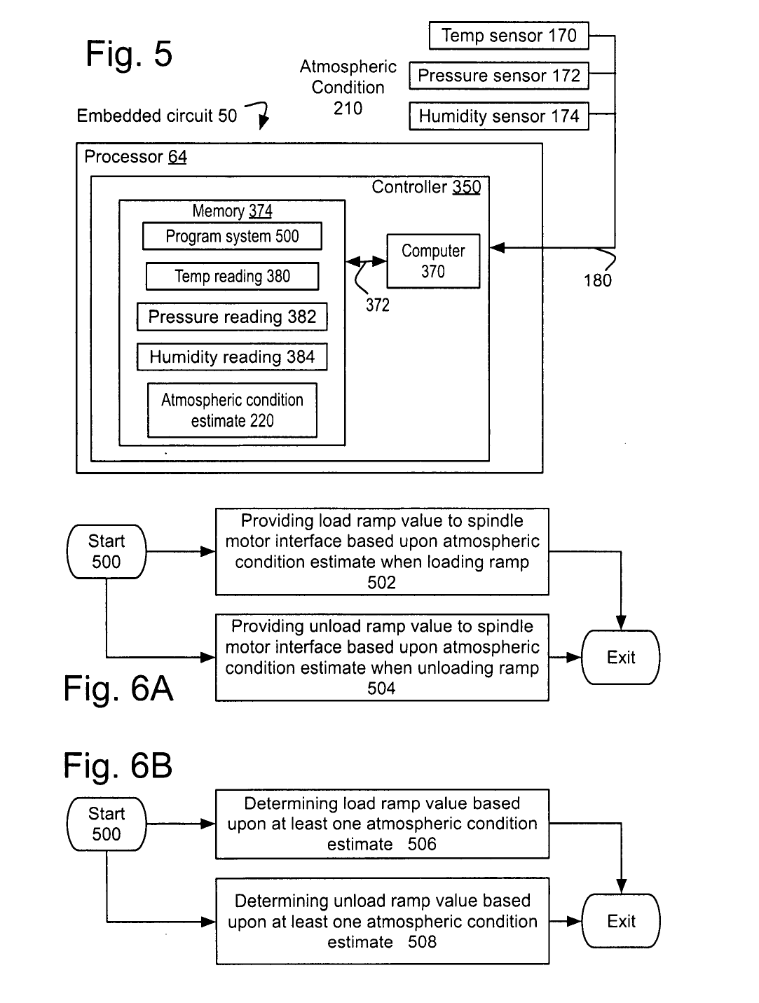

The embedded circuit 50 may preferably include at least one processor 64 communicating via communication coupling 180 to a temperature sensor 170 and also controllably coupled via coupling 182 to a motor control interface 74 to the spindle motor 14. The processor may use the temperature sensor to at least partly estimate the atmospheric condition 210, thereby creating the atmospheric condition estimate 220. The processor uses a ramp unload control value 222 and/or a ramp load control value 224 based upon the atmospheric condition estimate to generate the rotation control signal when unloading the sliders 20. The motor control interface may be included in the embedded circuit or in certain embodiments may be included in the printed circuit assembly 38, which may be separately mounted on the disk base 16. The embodiment in FIG. 3 shows a temperature sensor used as an atmospheric condition sensor because most existing disk drives already include the temperature sensor. However, in alternate embodiments (as will be discussed later in reference to FIG. 5) other or additional sensors may be used including but not limited to air pressure and humidity sensors.

When the disks reach an operational rotation rate, the processor then stimulates a position control signal 232 which acts as a time varying electrical stimulus to the voice coil 32 in the voice coil motor 36. From the stimulus to the voice coil and its magnetic interaction with the fixed magnet assembly 34, the actuator assembly pivots through the actuator pivot 30, sending the actuator arms 28 and their coupled head gimbal assemblies 26 to position a slider 20 near a track on the rotating disk surface 6. At this point, the hard disk drive enters into an operational mode referred to as track following and often uses the micro-actuator assembly 280 to laterally position the read-write head 24 close enough to the track for data access. During data access, the preamplifier often generates a position error signal used by the processor 64 in the embedded circuit 50 to control laterally positioning the slider 20 over the rotating disk 12. The processor stimulates a motor control interface 74 to create a rotation control signal 230 fed to the spindle motor 14, which responds by rotating the disks 12, creating the rotating disk surfaces.

The hard disk drive 10 performs a load ramp operation to remove the sliders 20 from data access. The embedded circuit 50 uses the load ramp value 224 to drive the motor control interface 74 through the control coupling 182. The motor control interface provides the rotation control signal 230 to the spindle motor 14 based upon the load ramp value, urging it to rotate the disks at the ramp speed 140. When this ramp speed is achieved the embedded circuit sends other control signals to the motor control interface to create a position control signal 232, which typically causes the voice coil motor 36, and in particular to the voice coil 32, which interacts with the fixed magnet assembly 34 to swing the sliders 20 out of the region of the disk surfaces used for data access. The sliders have been flying on the air bearing shown in FIG. 2B. After the sliders leave the data access region of the disk surfaces, the head gimbal assemblies 26, and in particular at least one load tab 274 seen in FIG. 2B, engage with the ramp in the hard disk drive, placing the sliders into a protective position.

The hard disk drive 10 also performs an unload operation to return the sliders 20 from their protective position. The embedded circuit 50 uses the unload ramp value 222 to drive the motor control interface 74, which provides the rotation control signal 230 to the spindle motor 14 based upon the unload ramp value, urging it to rotate the disks at the ramp speed 140. As with loading the sliders described in the previous paragraph, when the ramp speed is achieved, the embedded circuit sends other control signals to the motor control interface to create the position control signal 232, which typically causes the voice coil motor 36 to disengage the load tabs from the ramp, causing the sliders to swing onto the region of the disk surfaces used for data access. The wind from the rotating disk surface 6 forms the air bearing between the slider 20 and the rotating disk surface as shown in FIG. 2B.

Both the loading and unloading operations in the hard disk drive 10 are sensitive to the atmospheric condition 210 in the region including the sliders 20 and the rotating disk surfaces 6, because the air bearing is sensitive to these conditions. Various embodiments of the invention may use knowledge of the effects on the air bearing to use differing ramp speeds 140 as will be discussed shortly.

It should be noted that various embodiments of the hard disk drive 10 may incorporate the motor control interface 74 into the printed circuit assembly 38 or into the embedded circuit 50. Certain embodiments of the hard disk drive may further incorporate the motor control interface into the processor 64.

FIG. 4 shows an example simplified mechanical side view of one kind of embodiment of the hard disk drive 10 including the inside ramp 110 of FIG. 1 where the load tabs 274 of the head gimbal assemblies 26 seen in FIG. 2B engage the inside load ramp to rest the sliders on the surfaces of the disks 12, which stops rotating. Other ramp designs are useable in the invention.

In general, embodiments of the invention may vary the load and/or unload ramp speeds as required or desirable for increased performance and reliability. For example, a load ramp speed may differ from an unload ramp speed, and the difference may depend on one or more atmospheric conditions in the hard disk drive. Further, a first load ramp speed may differ from a second later load ramp speed, with the difference in speeds depending on differing atmospheric conditions in the hard disk drive. Similarly, a first unload ramp speed may differ from a second later unload ramp speed depending on differing atmospheric conditions in the hard disk drive.

The control of the spindle motor 14 is of necessity very precise in contemporary hard disk drives, so that two ramp speeds will be referred to as distinct if they differ from each other by more than one percent of their average.

The processor 64 of FIG. 3 may include at least one instance 340 of a controller 350. As used herein, a controller receives at least one input to create at least one state, and generating at least one output based upon at least one of the inputs and/or based upon at least one of the states. Instances of various embodiments of a controller may include any of the following: a finite state machine, an inference engine, a neural network, and/or a computer as shown in FIG. 5. As used herein, a computer includes at least one data processor and at least one instruction processor, where each of the data processors is at least partly directed by at least one of the instruction processors.

Some embodiments of the embedded circuit may preferably include two or more instances of controllers, one for encoding and decoding data payloads of sectors, and another for controlling the spindle motor, voice coil motor, and micro-actuator assemblies.

FIG. 5 shows in a simplified schematic fashion a refinement of FIG. 3 where in addition to the temperature sensor 170 the hard disk drive 10 further includes a pressure sensor 172 and a humidity sensor 174, both communicating via communication coupling 180 to the processor 310 in the embedded circuit 50. The processor includes a computer 370 accessibly coupling via a buss 372 with a memory 374. The memory includes a program system 500 at least partly directing the activities of the computer and at least partly implementing embodiments of the method of loading and/or unloading the sliders 20. The memory also includes a temperature reading 380 based upon data received from the temperature sensor 170 about the atmospheric condition 210, which may be used to create the atmospheric condition estimate 220. The memory may further include a pressure reading 382 and/or a humidity reading 384, one or both of which may be further used to create the atmospheric condition estimate.

An atmospheric condition 210 as used herein may include any combination of the temperature, the relative humidity, and the air pressure near the sliders 20 and rotating disk surfaces 6, which may be estimated based upon readings from atmospheric condition sensors 170, 172 and/or 174 to create an atmospheric condition estimate 220. As used herein an atmospheric condition sensor may include one or more of a temperature sensor 170, an air pressure sensor 172 and/or a humidity sensor 174 as shown in FIG. 5.

Two atmospheric conditions may differ from each other by a single atmospheric parameter, for instance, by a first temperature distinct from a second temperature. Alternatively, two atmospheric conditions may differ by more than one of the atmospheric parameters of temperature, relative humidity and/or air pressure.

These reading may be in standard units such as degrees Centigrade, percent relative humidity, millimeters of mercury, or they may be in the calibrated units of the sensors, which may for example range from 0 to 255.

Alternatively, an atmospheric condition 210 may refer to a range of conditions, for example, temperatures between 10 degrees and 15 degrees Centigrade, relative humidity between 10 and 30 percent, and air pressure as typically found on calm days between sea level and one thousand meter elevations. In such embodiments, two atmospheric conditions may differ if a combination of temperature and/or relative humidity and/or air pressure belongs in one but not the other atmospheric condition, for any such combination.

FIG. 6A shows a flowchart of an example detail of the program system 500 of FIG. 5, which may provide a load ramp value 224 (seen in FIG. 3) via the control coupling 182 through the motor control interface 74 to the spindle motor 14 based upon the atmospheric condition estimate 220 when loading the ramp 110 or 116 (seen in FIG. 1) and/or provide an unload ramp value 222 (seen in FIG. 3) to the spindle motor based upon the atmospheric condition estimate when unloading the ramp.

FIG. 6B shows a flowchart of another example detail of the program system 500 of FIG. 5 which may determine the load ramp value 224 based upon at least one atmospheric condition estimate 220 and/or may determine the unload ramp value 222 based upon the at least one atmospheric condition estimate 220.

The preceding embodiments provide examples of the invention and are not meant to constrain the scope of the following claims.

What is claimed is:

1. A disk drive comprising:
a disk base;
a spindle motor mounted on said disk base;
at least one disk rotatably coupled to said spindle motor to create at least one rotating disk surface when said spindle motor rotates said disk at ramp speeds selected based upon at least one atmospheric condition;
an actuator assembly pivotably mounted to said disk base by an actuator pivot, comprising at least one head gimbal assembly for positioning a read-write head in a slider near said rotating disk surface;
a ramp mounted to a member of the group consisting of said disk base and said spindle motor, wherein said ramp speeds are used in at least one member of the ramp operation group consisting of a loading operation of said slider onto said ramp and an unloading operation of said slider from said ramp; and
an embedded circuit controlling a rotation control signal to stimulate said spindle motor to rotate said disk at said ramp speeds for performing said members of said ramp operation group.

2. The disk drive of claim 1, wherein said atmospheric condition including at least one instance of at least one member of the group consisting of a temperature, a pressure and a humidity.

3. The disk drive of claim 1, wherein said ramp speeds include a load ramp speed differing from an unload ramp speed;
wherein said spindle motor rotates said at least one disk at said load ramp speed based upon said atmospheric condition for said loading operation;
wherein said spindle motor rotates said at least one disk at said unload ramp speed based upon said atmospheric condition for said unloading operation.

4. The disk drive of claim 1, wherein said ramp speeds include a first load ramp speed differing from a second load ramp speed;
wherein said spindle motor rotates said at least one disk at said first load ramp speed based upon a first of said atmospheric conditions for said loading operation;
wherein said spindle motor rotates said at least one disk at said second load ramp speed based upon a second of said atmospheric conditions for said loading operation.

5. The disk drive of claim 1, wherein said ramp speeds include a first unload ramp speed differing from a second unload ramp speed;
wherein said spindle motor rotates said at least one disk at said first unload ramp speed based upon a first of said atmospheric conditions for said unloading operation;
wherein said spindle motor rotates said at least one disk at said second unload ramp speed based upon a second of said atmospheric conditions for said unloading operation.

6. The disk drive of claim 1, wherein said embedded circuit is electrically coupled to at least one member of the sensor group consisting of:
a temperature sensor,
a pressure sensor, a humidity sensor, and
each member of said sensor group responding to an atmospheric condition to create an atmospheric condition estimate, said embedded circuit controlling said disk rotation based upon at least one of said atmospheric condition estimates.

7. The disk drive of claim 1, wherein said ramp is an inside ramp for parking each of said sliders.

8. The disk drive of claim 1, wherein said ramp is an outside ramp for parking each of said sliders.

9. A method of operating a disk drive, comprising the steps of:
rotating each disk included in said disk drive with at least two ramp speeds based upon at least one atmospheric condition while performing at least one member of the ramp operation group consisting of a loading operation of a slider onto a ramp and an unloading operation of said slider from said ramp;
wherein said ramp speeds differ;
wherein each of said atmospheric conditions includes at least one instance of at least one member of the group consisting of a temperature, a pressure and a humidity.

10. The method of claim 9, comprising the steps of:
rotating each of said disks at a load ramp speed based upon said atmospheric condition for said loading operation; and
rotating each of said disks at an unload ramp speed based upon said atmospheric condition for said unloading operation; and
wherein said load ramp speed differs from said unload ramp speed.

11. The method of claim 9, comprising the steps of:
rotating each of said disks at a first load ramp speed based upon a first of said atmospheric conditions for said loading operation; and
rotating each of said disks at a second load ramp speed based upon a second of said atmospheric condition for said loading operation; and
wherein said first load ramp speed differs from said second load ramp speed.

12. The method of claim 9, comprising the steps of:
rotating each of said disks at a first unload ramp speed based upon a third of said atmospheric conditions for said unloading operation; and
rotating each of said disks at a second unload ramp speed based upon a fourth of said atmospheric condition for said unloading operation; and
wherein said first unload ramp speed differs from said second unload ramp speed.

13. A control circuit for controlling a rotation control signal to stimulate a spindle motor to rotate a disk at ramp speeds selected based upon a signal received by said circuit providing data regarding at least one atmospheric condition.

14. The control circuit of claim 13, wherein said ramp speeds are used in at least one member of the ramp operation group consisting of a loading operation of a slider onto a ramp and an unloading operation of said slider from said ramp.

15. The control circuit of claim 13, wherein said at least one atmospheric condition includes at least one instance of at least one member of the group consisting of a temperature, a pressure and a humidity.
